(19) United States
(12) Patent Application Publication
(10) Pub. No.: US 2011/0119967 A1
(43) Pub. Date: May 26, 2011

(54) SYSTEM AND METHOD FOR RECORDING CUSTOMIZED AUDIO MESSAGES FOR GREETING CARDS

(75) Inventor: Gary M. Kawesch, San Jose, CA (US)

(73) Assignee: Laser Eye Center of Silicon Valley, San Jose, CA (US)

(21) Appl. No.: 12/954,286

(22) Filed: Nov. 24, 2010

Related U.S. Application Data
(60) Provisional application No. 61/264,413, filed on Nov. 25, 2009.

(51) Int. Cl. G09F 1/00

(52) U.S. Cl. 40/124.03

(57) ABSTRACT

A system and method for recording a customized greeting to be utilized in connection with a greeting device such as a card includes providing a single use or multiuse recordable device on the greeting card. The recordable device is coupled by a removable and/or disposable cable or by a wireless connection to an electronic device such as a computer, MP3 player or other processing device capable of transferring files. A user records or downloads one or more music, voice or audio file(s) he or she wants to transfer to the recordable device on the greeting card and subsequently transfers the file(s) to the recordable device. In the case where the user utilizes a cable, the user then removes, cuts or tears the cable from the greeting card. The greeting card can then be delivered or mailed in a traditional manner with a customized recording.

### CROSS-REFERENCE TO RELATED APPLICATIONS

This application claims priority from U.S. Provisional Patent Application No. 61/264,413, which was filed on Nov. 25, 2009 and incorporated fully herein by reference.

### TECHNICAL FIELD

The present invention relates to greeting cards and more particularly, to a greeting card with electronic digital storage and playback capabilities that is removably attachable to a processing device.

### BACKGROUND

Greeting cards are an enormous industry, with cards available for every event, situation and holiday imaginable. Individuals send greeting cards for any and all such occasions. Traditionally, greeting cards are provided with preprinted greetings or sayings or alternatively, may be blank. More recently, it is possible to purchase a greeting card with a prerecorded sound or audio message which plays upon opening the greeting card. Although a greeting card with the ability to play audio is a nice feature, and some cards allow for through the air microphone-based recording of original audio onto the card, it is generally not possible for the user to electronically download to the card customized audio content he or she wishes to have played when the card is opened.

There are other items in the gift industry that provide a user recordable device. For example, it is not uncommon in a stuffed animal retail store for a user to be able to purchase a device on which he or she can record a personalized message for use with a particular stuffed animal. These devices do, however, suffer from several drawbacks. First, the devices are quite large because they include recording circuitry and microphone, playback circuitry and speaker, battery and a button or other device which is used to activate the recording mode and subsequently activate the playback mode. These devices are too large (especially too “thick”) to be placed on a traditional paper greeting card given their need to have both recording circuitry and play back circuitry. Such cards would subsequently not the able to be shipped through the mail or would require prohibitively expensive postage. Moreover, although a user can record his or her voice, it is typically not possible at such a retail establishment to record a user's own desired music, sounds, other recordings, or the combination of a user's desired music, sounds and/or voice.

Accordingly, what is needed is a system and method which allows a user to connect a generally small and thin recordable device located on a greeting card using a removable and/or disposable cable to an electronic device such as a computer from which one or more voice, music or audio file can be downloaded to the recordable device on the greeting card. Once the recording has taken place, the cable to the electronic device can be removed, cur or otherwise severed and even perhaps disposed of allowing the card to be appear and be utilized in a conventional manner.

### SUMMARY

The present invention features a greeting card comprising a writable, electronic storage device, located on the greeting card, and configured for receiving and storing audio information, and responsive to an activation device, for providing the received and stored audio information to an audio speaker and responsive to the activation device, for terminating the providing of the received and stored audio information to the audio speaker. An audio speaker, electronically coupled to the writable, electronic storage device and configured for playing audio information received from the writable, electronic storage device is provided. Also provided is a power source, located on the greeting card and coupled to the writable, electronic storage device, and configured for providing power to the writable, electronic storage device.

The invention includes an audio information electronic cable, generally securely electronically coupled to the writable, electronic storage device, for electronically coupling the writable, electronic storage device and a source of audio information. The audio information electronic cable is also configured for allowing the source of audio information to download audio information to be received by and stored on the writable, electronic storage device, the audio information electronic cable being further configured for being easily uncoupled from the writable, electronic storage device on demand of a user.

In the preferred embodiment, the audio information electronic cable is a one-time use cable that can be disconnected, torn or cut or otherwise removed from connection with the writable, electronic storage device such as a flat flex cable such that any remaining cable, if any, left attached to the module, will not be visible outside the card. The flat flex audio information electronic cable may be perforated to allow for easy separation of the cable from the writable, electronic storage device recordable chip. In another embodiment, the writable, electronic storage device may be part of a wireless module located on the card that receives audio information wirelessly from a device such as a computer, a CD player, an MP3 player a smart phone and/or the like equipped with a wireless transmitter.

The greeting card may comprise a written greeting on at least one surface of the greeting card. The power source is preferably a small battery while the source of audio information may be selected from the group consisting of a computer, a CD player, an MP3 player and a smart phone while the audio information may include one or more files selected from the group consisting of audio, voice, music or sound files.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention.

### BRIEF DESCRIPTION OF THE DRAWINGS

These and other features and advantages of the present invention will be better understood by reading the following detailed description, taken together with the drawings wherein:

FIG. 1 is a top plan view of a greeting card and electronic device in accordance with the system and method of the present invention.

### DETAILED DESCRIPTION OF THE PREFERRED EMBODIMENTS

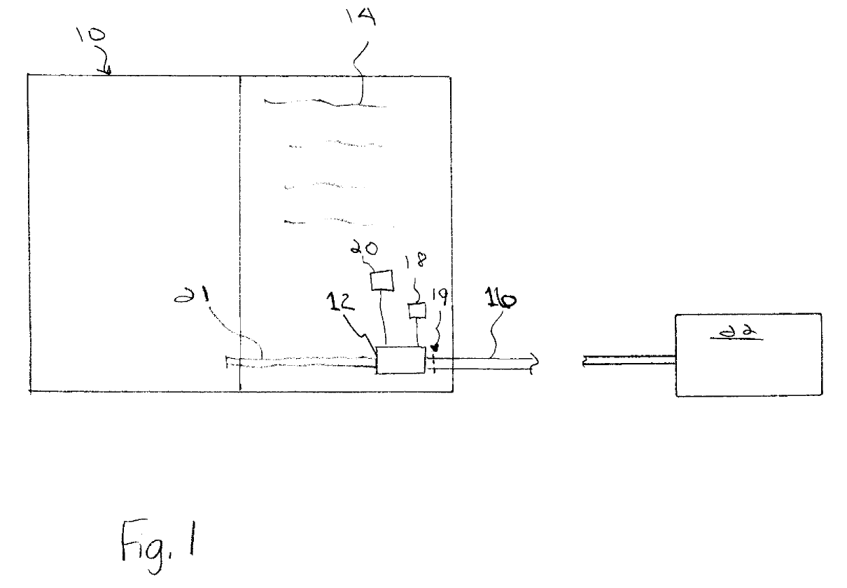

The present invention features a greeting card 10, FIG. 1. The greeting card may be a traditional paper card or may be made of another material or may be of a type of greeting device other than a “traditional” greeting card such as including but not limited to a box, an envelope, a gift item, a stuffed animal or other element. The greeting card may or may not be provided with a conventional written greeting 14.

The greeting card 10 in accordance with the present invention includes or is provided with a single or multi-use recordable electronic device or chip 12 coupled to a power source 18 such as a small battery and a small speaker 20 from which a recording is played and can be heard by the recipient. This technology is well known in the art as certain greeting cards are presently provided with pre-recorded greetings or audio information such as music.

The writable, electronic storage device 12 also called a recordable chip is coupled to an activation device 21 such as a sliding lever in a greeting card; a pressure sensitive element, or any other device that can detect some activation or movement of the greeting card or other gift item and which would signify that the audio information recorded on the recordable chip 12 should begin to play, and which subsequent movement or the de-activation of the activation device can also signify when the recordable chip should stop playing the audio information.

In accordance with the present invention, the recordable chip 12 is, in one embodiment, connected either directly or indirectly to a cable 16 which allows the chip 12 to be connected to an electronic device 22 such as a computer, CD player, MP3 player, Smart phone or other similar processing device. The cable 16 is preferably supplied with the greeting card or other greeting device 10 and is removable or severable from the greeting device 10 and/or the recordable chip 12 and preferably disposable. In another embodiment, the chip 12 may be provided as part of a circuit that is equipped with a wireless receiver, such as a blue tooth receiver or the like, to enable an electronic device 22 such as a computer, CD player, MP3 player, Smart phone or other similar processing device to transmit user recorded or assembled audio information wirelessly to the chip 12 for later playback, as described herein.

The electronic device 22 permits a user to select one or more prerecorded music, voice or sound files which the user himself or herself has recorded or which the user has downloaded and stored on the electronic device 22. The user may select a single file or the user may combine together multiple files.

In this configuration, the chip 12 functions with the electronic device 22 as a plug-and-play storage device that allows a user to select a file or files of proper size which will fit on the recordable chip 12 and transfer them from the electronic device 22 to the recordable chip 12 using the supplied cable 16 or wirelessly. After the transfer of the file or files to the recordable chip 12, the cable 16 (is used) is disconnected or severed from the recordable chip 12 and either saved or discarded. Any cable remaining on the greeting device 10 is not visible to the recipient and thus does not interfere with the enjoyment and use of the greeting card or device 10.

In one embodiment, the cable 16 may be a reusable cable such as a USB, firewire, serial or other currently accepted standard connectable data communication cable or alternatively and more preferably, may be a onetime use cable. The cable 16 may include a standard type connector presently available or of a standard which is not yet available or developed. Any connector provided should have a profile that fits within the form of a greeting card or appropriate to any other greeting device type 10.

The connection between the cable 16 and the recordable chip 12 must be such that the cable 16 is not likely to become disconnected during transit and display of the greeting device 10 yet will allow for easy disconnection using only light to moderate force.

The one time use cable 16 is preferably a flat ribbon cable that may be connected using an appropriate connector to the recordable chip 12 of any electronic module that the chip 12 is located on or alternatively, perforated at or near the recordable chip 12 (as shown for example at 19) and which can be torn or cut (with or without perforations) from connection with the chip 12 and greeting card 10 and then discarded without impairing the functionality of the chip. Flat, flexible ribbon cables and their connectors are well known in the art and present a very low profile or thickness and thus any connector or ribbon cable piece 16 remaining on the greeting card 10 may remain easily hidden under a piece of the greeting card 10. Alternatively, the cable 16 may have a male or female connector which joins with a corresponding gender connector with the chip 12 or a circuit on which the chip 12, battery and speaker are mounted within the card or other greeting 10, and which cable 16 is detachable once the audio file is transferred to the chip 12.

In this manner and utilizing the system and method of the present invention, a user may create or select one or more voice files, music files, or audio files from the electronic device 22; download the file(s) to the recordable device 12 using a cable or wirelessly; and subsequently disengage the download cable 16, resulting in a traditional looking greeting card 10 with the added benefit of a customized, audio message that plays when the greeting card opens as is common in the existing prior art pre-recorded chips.

The present invention is not intended to be limited to a device or method which must satisfy one or more of any stated or implied objects or features of the invention and should not be limited to the preferred, exemplary, or primary embodiment(s) described herein. Modifications and substitutions by one ordinary skill in the art are considered to be within the scope of the present invention which is not to be limited except by the allowed claims and their legal equivalents.

In the invention claimed is:

1. A greeting device comprising:
a writable, electronic storage device, located on said greeting card, and configured for receiving and storing audio information, and responsive to an activation device, for providing said received and stored audio information to an audio speaker and also responsive to said activation device, for terminating the providing of said received and stored audio information to said audio speaker;
an audio speaker, electronically coupled to said writable, electronic storage device and configured for playing audio information received from said writable, electronic storage device;
a power source, located on said greeting card and coupled to said writable, electronic storage device, and configured for providing power to said writable, electronic storage device; and
means for electronically coupling said writable, electronic storage device and a source of audio information, said means configured for allowing said source of audio information to download audio information to be received by and stored on said writable, electronic storage device.

2. The greeting device of claim 1, wherein said means for electronically coupling said writable, electronic storage device and a source of audio information includes an audio information electronic cable, generally securely electronically coupled to said writable, electronic storage device, for electronically coupling said writable, electronic storage device and a source of audio information, said audio information electronic cable configured for allowing said source of audio information to download audio information to be received by and stored on said writable, electronic storage device, said audio information electronic cable further configured for being easily uncoupled from said writable, electronic storage device on demand of a user.

3. The greeting device of claim 2, wherein the audio information electronic cable is a one-time use cable that can be disconnected, torn or cut from connection with said writable, electronic storage device.

4. The greeting device of claim 3, wherein the audio information electronic cable is a flat flex cable.

5. The greeting device of claim 4, wherein the flat flex audio information electronic cable is perforated to allow for easy separation of the cable from the writable, electronic storage device recordable chip.

6. The greeting device of claim 1 further comprising a written greeting on at least one surface of the greeting card.

7. The greeting device of claim 1 wherein the power source is a small battery.

8. The greeting device of claim 1, wherein the source of audio information is selected from the group consisting of a computer, a CD player, an MP3 player and a smart phone.

9. The greeting device of claim 1, wherein said audio information includes one or more files selected from the group consisting of audio, voice, music or sound files.

10. The greeting device of claim 1, wherein the greeting device is selected from the group consisting of a greeting card, an envelope, a box, and a stuffed animal.

11. The greeting device of claim 1, where said means for electronically coupling said writable, electronic storage device and a source of audio information includes a wireless connection between said electronic storage device and a source of audio information.

12. A greeting card comprising:
a writable, electronic storage device, located on said greeting card, and configured for receiving and storing audio information, and responsive to an activation device, for providing said received and stored audio information to an audio speaker;
an audio speaker, electronically coupled to said writable, electronic storage device and configured for playing audio information received from said writable, electronic storage device;
a power source, located on said greeting card and coupled to said writable, electronic storage device, and configured for providing power to said writable, electronic storage device; and
an audio information electronic cable, generally securely electronically coupled to said writable, electronic storage device, for electronically coupling said writable, electronic storage device and a source of audio information, said audio information electronic cable configured for allowing said source of audio information to download audio information to be received by and stored on said writable, electronic storage device, said audio information electronic cable further configured for being easily uncoupled from said writable, electronic storage device on demand of a user, wherein said audio information electronic cable is a flat flex audio information cable and wherein said flat flex audio information electronic cable is configured to allow for easy separation of the cable from the writable, electronic storage device recordable chip.

13. A method of recording one or more files onto a greeting card, the method comprising the following acts:
attaching a greeting card that includes a writable, electronic storage device, a power source, a speaker and an audio information electronic cable, generally securely electronically coupled to said writable, electronic storage device, to an electronic device, wherein the audio information electronic cable is a one-time use cable that can be unplugged, torn or cut from connection with said writable, electronic storage device;
transferring one or more audio files from the electronic device to the writable, electronic storage device; and
unplugging, tearing or cutting the audio information electronic cable from the greeting card.

14. The greeting card of claim 13, wherein the audio information electronic cable is a flat flex cable.

15. The greeting card of claim 14, wherein the flat flex audio information electronic cable is perforated to allow for easy separation of the cable from the writable, electronic storage device recordable chip.

16. The greeting card of claim 13 further comprising a written greeting on at least one surface of the greeting card.

17. The greeting card of claim 13 wherein the power source is a small battery.

18. The greeting card of claim 13, wherein the source of audio information is selected from the group consisting of a computer, a CD player, an MP3 player and a smart phone.

19. The greeting card of claim 13, wherein said audio information includes one or more files selected from the group consisting of audio, voice, music or sound files.
